(19) United States
(12) Patent Application Publication
(10) Pub. No.: US 2006/0248069 A1
(43) Pub. Date: Nov. 2, 2006

(54) Method and system for implementing customizable container services as component wireless applications

(75) Inventors: Richard X. Qing, Ottawa (CA); David Yach, Waterloo (CA); Michael Shenfield, Richmond Hill (CA); Jeffrey C. Rogers, Scarborough (CA); Kamen B. Vitanov, Mississauga (CA); Ken Wallis, Oakville (CA); Viera Bibr, Kilbride (CA); Bryan R. Goring, Milton (CA)

Correspondence Address: OGILVY RENAULT LLP, 1981 MCGILL COLLEGE AVENUE, SUITE 1600, MONTREAL, QC, H3A2Y3, CA

(73) Assignee: Research In Motion Limited, Waterloo (CA)

(21) Appl. No.: 11/157,975

(22) Filed: Jun. 22, 2005

Related U.S. Application Data
(60) Provisional application No. 60/672,086, filed on Apr. 18, 2005.

(51) Int. Cl. G06F 17/30; G06F 7/00

(52) U.S. Cl. 707/4

(57) ABSTRACT

A method for introducing a service to a runtime environment of a wireless device, the service for supporting at least one application in the runtime environment, the wireless device communicating over a wireless network with a data processing system, the method comprising: configuring the service as a system application, wherein the system application is adapted to: communicate system and application level messaging with the data processing system and at least one other service in the runtime environment; and, communicate application level messaging with the at least one application in the runtime environment; and, installing the system application in the runtime environment as an application.

This application claims priority from U.S. Provisional Patent Application No. 60/672,086, filed Apr. 18, 2005, and incorporated herein by reference.

### FIELD OF THE INVENTION

This invention relates to the field of wireless communications, and more specifically, to implementing customizable application container services as component applications for wireless and other devices.

### BACKGROUND

Current wireless mobile communication devices include microprocessors, memory, soundcards, and run one or more software applications. Examples of software applications used in these wireless devices include micro-browsers, address books, email clients, instant messaging (“IM”) clients, and wavetable instruments. Additionally, wireless devices have access to a plurality of services via the Internet. A wireless device may, for example, be used to browse web sites on the Internet, to transmit and receive graphics, and to execute streaming audio and/or video applications. The transfer of Internet content to and from wireless device is typically facilitated by the Wireless Application Protocol (“WAP”), which integrates the Internet and other networks with wireless network platforms.

With respect to wireless device services, currently, services offered in the application runtime environment of a wireless device are typically embedded in the runtime environment itself. As a result, these services are not customizable or extensible. Any replacements or changes to these services typically require that a replacement or change within the runtime environment be made by the original vendor of the runtime environment or by a third party who is licensed by the original vendor to do so. Consequently, introducing new services to the runtime environment without the involvement of the original vendor is problematic or impossible.

For reference, the term “runtime” refers to that time when an application or program is running (or being executable). That is, when a program starts running in a computer, it is runtime for that program. In some programming languages, certain reusable programs or routines are built and packaged as a runtime library. These routines can be linked to and used by any program when it is running. Thus, the term “runtime environment” refers to the collection of routines, variables, etc., that provide commonly used functions, services, data, etc., for a program while it is running.

The term “runtime environment” can also be understood as a context in which an application can be loaded and executed. For example, Java Virtual Machines (“JVM”)can be regarded as a runtime environment. So can an operating system in the sense that a user can load and run applications in the operating system even though the operating system is more than an runtime environment. While a runtime environment contains commonly used collections of functions or function libraries, it also provides built-in services. These services are crucial for a runtime environment. For example, JVM has a built-in garbage collection service, a Java™ class loading service, and a threading management service that are regarded as fundamental services of that runtime environment.

Thus, a distinction exists between application and services in a runtime environment. One of the basic functions of a runtime environment is to load an application. That is, a user can always add a new application or upgrade an existing application without changing the runtime environment itself. However, this is not the case for services in the runtime environment. Traditionally, the runtime environment itself would have to be changed upon adding or upgrading services as these services are directly embedded in the runtime environment.

A need therefore exists for an effective method and system for dynamically introducing new services to, and upgrading existing services in, the runtime environment of wireless and other devices, without changing the runtime environment itself. Accordingly, a solution that addresses, at least in part, the above and other shortcomings is desired.

### SUMMARY

The present invention provides a method for organizing, introducing, and configuring services in the runtime environment of wireless and other devices. In particular, the present invention provides a method for dynamically adding and/or upgrading services in such a runtime environment without changing the runtime environment itself. This is accomplished by implementing certain services of the runtime environment as component applications that have system level access privileges (referred to as “system component wireless applications” in the following). Advantageously, a user can add or upgrade existing services that are implemented as system component wireless applications by simply deploying these as regular applications, without changing the runtime environment itself.

According to one aspect of the invention, there is provided a method for introducing a service to a runtime environment of a wireless device, the service for supporting at least one application in the runtime environment, the wireless device communicating over a wireless network with a data processing system, the method comprising: configuring the service as a system application, wherein the system application is adapted to: communicate system and application level messaging with the data processing system and at least one other service in the runtime environment; and, communicate application level messaging with the at least one application in the runtime environment; and, installing the system application in the runtime environment as an application.

In accordance with further aspects of the present invention there is provided an apparatus such as a data processing system or wireless device, a method for adapting this system or device, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system adapted for implementing an embodiment of the invention;

FIG. 2 is a block diagram illustrating a wireless device and a wireless communications system adapted for implementing an embodiment of the invention;

FIG. 3 is a block diagram illustrating a memory of the wireless device of FIG. 2;

FIG. 4 is a block diagram illustrating an application container in accordance with an embodiment of the invention;

FIG. 5 is a block diagram flow chart illustrating operations of modules for application container access control in accordance with an embodiment of the invention;

FIG. 6 is a block diagram flow chart illustrating operations of modules for installing, replacing, and updating component wireless applications (“CWAs”) in accordance with an embodiment of the invention; and,

FIG. 7 is a block diagram illustrating an application container having customizable services in accordance with an embodiment of the invention.

It will be noted that throughout the appended drawings, like features are identified by like reference numerals.

### DETAILED DESCRIPTION OF THE PREFERRED EMBODIMENTS

The following detailed description of the embodiments of the present invention does not limit the implementation of the invention to any particular computer programming language. The present invention may be implemented in any computer programming language provided that the operating system (“OS”) provides the facilities that may support the requirements of the present invention. A preferred embodiment is implemented in the JAVA™ computer programming language (or other computer programming languages such as C or C++). (JAVA and all JAVA-based trademarks are the trademarks of Sun Microsystems Corporation.) Any limitations presented would be a result of a particular type of operating system or computer programming language and would not be a limitation of the present invention.

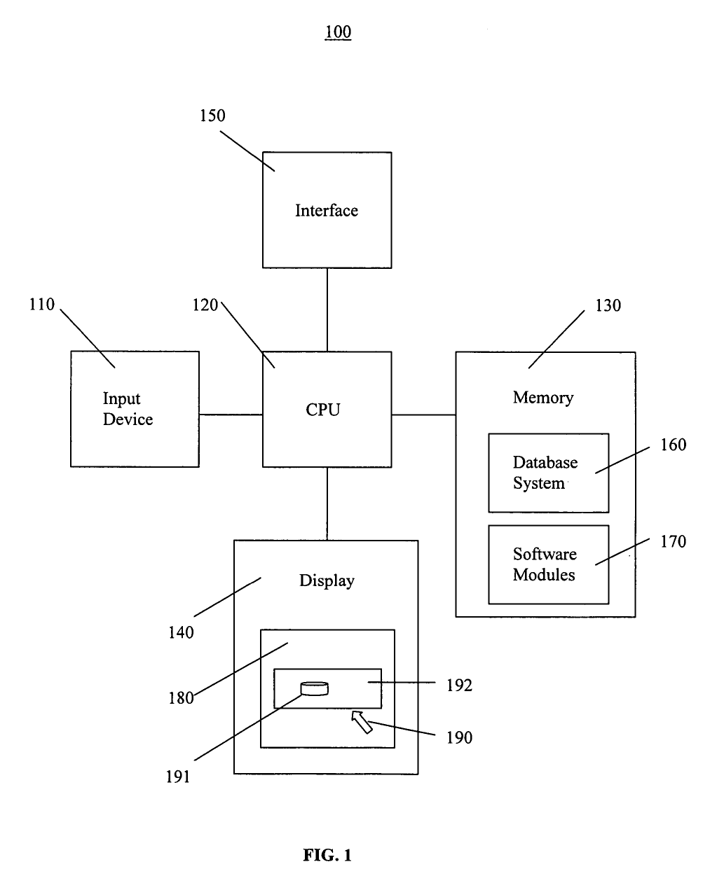

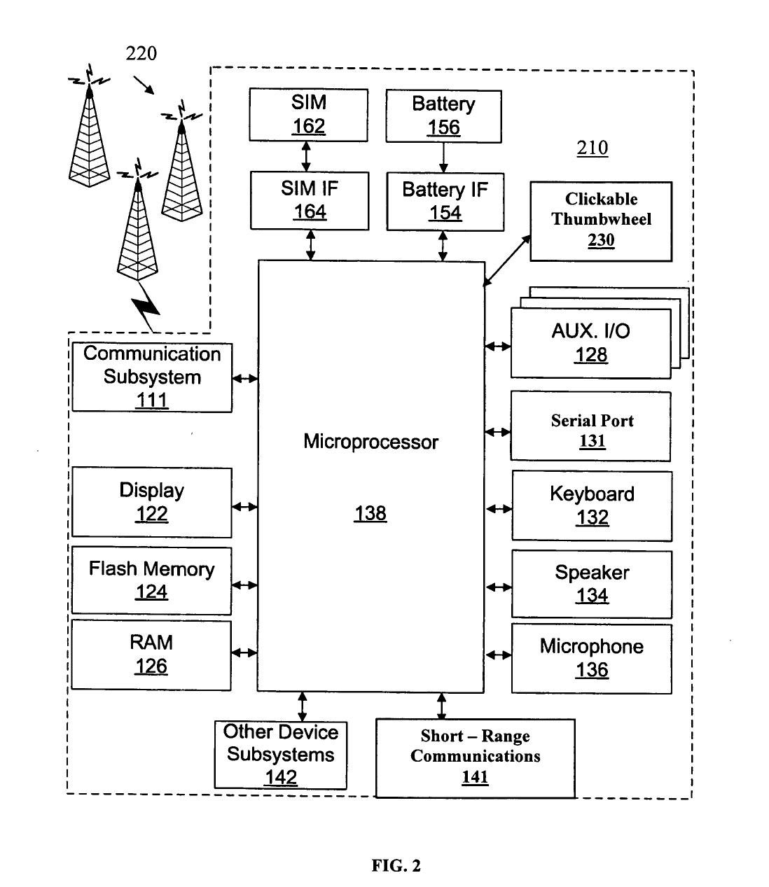

FIG. 1 is a block diagram illustrating a data processing system 100 adapted for implementing an embodiment of the invention. The data processing system 100 includes an input device 110, a central processing unit or CPU 120, memory 130, a display 140, and an interface 150. The input device 110 may include a keyboard, mouse, trackball, remote control, or similar device. The CPU 120 may include dedicated coprocessors and memory devices. The memory 130 may include RAM, ROM, or disk devices. The display 140 may include a computer screen, terminal device, or a hardcopy producing output device such as a printer or plotter. And, the interface 150 may include a network connection including an Internet connection and a wireless network 220 connection (see FIG. 2). The data processing system 100 is adapted for communicating with wireless devices 210 over a wireless network 220.

The data processing system 100 may be a server system or a personal computer (“PC”) system. The CPU 120 of the system 100 is operatively coupled to memory 130 which stores an operating system (not shown), such as IBM Corporation's OS/2™, UNIX, etc., for general management of the system 100. The interface 150 may be used for communicating to external data processing systems (not shown) through a network (such as the Internet) or wireless network 220 (see FIG. 2). Examples of suitable platforms for the system 100 include iSeries™ servers and ThinkCentre™ personal computers available from IBM Corporation. The system 100 may include application server software (not shown), such as WebLogic® Server available from BEA Systems, Inc., for developing and managing distributed applications.

The data processing system 100 may include a database system 160 for storing and accessing programming information. The database system 160 may include a database management system (“DBMS”) and a database and is stored in the memory 130 of the data processing system 100.

The data processing system 100 includes computer executable programmed instructions for directing the system 100 to implement the embodiments of the present invention. The programmed instructions may be embodied in one or more software modules 170 resident in the memory 130 of the data processing system 100. Alternatively, the programmed instructions may be embodied on a computer readable medium (such as a CD disk or floppy disk) which may be used for transporting the programmed instructions to the memory 130 of the data processing system 100. Alternatively, the programmed instructions may be embedded in a computer-readable, signal-bearing medium that is uploaded to a network by a vendor or supplier of the programmed instructions, and this signal-bearing medium may be downloaded through the interface 150 to the data processing system 100 from the network by end users or potential buyers.

The CPU 120 of the system 100 is typically coupled to one or more devices 110 for receiving user commands or queries and for displaying the results of these commands or queries to the user on a display 140. As mentioned, the memory 130 may include a variety of storage devices including internal memory and external mass storage typically arranged in a hierarchy of storage as understood to those skilled in the art.

A user may interact with the data processing system 100 and its software modules 170 using a graphical user interface (“GUI”) 180. The GUI 180 may be web-based and may be used for monitoring, managing, and accessing the data processing system 100. GUIs are supported by common operating systems and provide a display format which enables a user to choose commands, execute application programs, manage computer files, and perform other functions by selecting pictorial representations known as icons, or items from a menu through use of an input or pointing device such as a mouse 110. In general, a GUI is used to convey information to and receive commands from users and generally includes a variety of GUI objects or controls, including icons, toolbars, drop-down menus, text, dialog boxes, buttons, and the like. A user typically interacts with a GUI 180 presented on a display 140 by using an input or pointing device (e.g., a mouse) 110 to position a pointer or cursor 190 over an object 191 and by “clicking” on the object 191.

Typically, a GUI based system presents application, system status, and other information to the user in “windows” appearing on the display 140. A window 192 is a more or less rectangular area within the display 140 in which a user may view an application or a document. Such a window 192 may be open, closed, displayed full screen, reduced to an icon, increased or reduced in size, or moved to different areas of the display 140. Multiple windows may be displayed simultaneously, such as: windows included within other windows, windows overlapping other windows, or windows tiled within the display area.

FIG. 2 is a block diagram illustrating a wireless device 210 and a wireless network 220 adapted for implementing an embodiment of the invention. The wireless network 220 includes antenna, base stations, and supporting radio equipment, known to those of ordinary skill in the art, for supporting wireless communications between the wireless device 210 and the data processing system 100. The wireless network 220 may be coupled to a wireless network gateway (not shown) and to a wide area network (not shown) to which the data processing system 100 may be coupled through its interface 150.

The wireless device 210 is a two-way communication device having at least voice and advanced data communication capabilities, including the capability to communicate with other computer systems 100. Depending on the functionality provided by the device 210, it may be referred to as a data messaging device, a two-way pager, a cellular telephone with data messaging capabilities, a wireless Internet appliance, or a data communication device (with or without telephony capabilities). The device 210 may communicate with any one of a plurality of fixed transceiver stations 220 within its geographic coverage area.

The wireless device 210 will normally incorporate a communication subsystem 111, which includes a RF receiver, a RF transmitter, and associated components, such as one or more (preferably embedded or internal) antenna elements, local oscillators (“LOs”), and a processing module such as a digital signal processor (“DSP”) (all not shown). As will be apparent to those skilled in the field of communications, the particular design of the communication subsystem 111 depends on the communication network 220 in which the device 210 is intended to operate.

Network access is associated with a subscriber or user of the device 210 and therefore the device 210 typically has a Subscriber Identity Module (or “SIM” card) 162 to be inserted in a SIM interface (“IF”) 164 in order to operate on the network (e.g., a GSM network). The device 210 is a battery-powered device so it also includes a battery IF 154 for receiving one or more rechargeable batteries 156. Such a battery 156 provides electrical power to most if not all electrical circuitry in the device 210, and the battery IF 154 provides for a mechanical and electrical connection for it. The battery IF 154 is coupled to a regulator (not shown) which provides power to the circuitry of the device 210.

The wireless device 210 includes a microprocessor 138 which controls overall operation of the device 210. Communication functions, including at least data and voice communications, are performed through the communication subsystem 111. The microprocessor 138 also interacts with additional device subsystems such as a display 122, a flash memory 124 or other persistent store, a random access memory (“RAM ”) 126, auxiliary input/output (“I/O”) subsystems 128, a serial port 131, a keyboard 132, a clickable thumbwheel 230, a speaker 134, a microphone 136, a short-range communications subsystem 141, and any other device subsystems generally designated at 142. Some of the subsystems shown in FIG. 2 perform communication-related functions, whereas other subsystems may provide “resident” or on-device functions. Notably, some subsystems, such as the keyboard 132, display 122, and clickable thumbwheel 230, for example, may be used for both communication-related functions, such as entering a text message for transmission over a communication network, and device-resident functions such as a calculator or task list. Operating system software used by the microprocessor 138 is preferably stored in a persistent store such as the flash memory 124, which may alternatively be a read-only memory (“ROM”) or similar storage element (not shown). Those skilled in the art will appreciate that the operating system, specific device applications, or parts thereof, may be temporarily loaded into a volatile store such as RAM 126.

The microprocessor 138, in addition to its operating system functions, preferably enables execution of software applications on the device 210. A predetermined set of applications which control basic device operations, including at least data and voice communication applications, will normally be installed on the device 210 during its manufacture. A preferred application that may be loaded onto the device 210 may be a personal information manager (“PIM”) application having the ability to organize and manage data items relating to the user such as, but not limited to, instant messaging (“IM”), email, calendar events, voice mails, appointments, and task items. Naturally, one or more memory stores are available on the device 210 and SIM 162 to facilitate storage of PIM data items and other information.

The PIM application preferably has the ability to send and receive data items via the wireless network 220. In a preferred embodiment, PIM data items are seamlessly integrated, synchronized, and updated via the wireless network, with the wireless device user's corresponding data items stored and/or associated with a host computer system such as the data processing system 100 thereby creating a mirrored host computer on the device 210 with respect to such items. This is especially advantageous where the host computer system is the wireless device user's office computer system. Additional applications may also be loaded onto the device 210 through the network 220, the auxiliary I/O subsystem 128, the serial port 131, the short-range communications subsystem 141, or any other suitable subsystem 142, and installed by a user in RAM 126 or preferably in a non-volatile store (not shown) for execution by the microprocessor 138. Such flexibility in application installation increases the functionality of the device 210 and may provide enhanced on-device functions, communication-related functions, or both. For example, secure communication applications may enable electronic commerce functions and other such financial transactions to be performed using the wireless device 210.

In a data communication mode, a received signal such as a text message, an email message, or web page download will be processed by the communication subsystem 111 and input to the microprocessor 138. The microprocessor 138 will preferably further process the signal for output to the display 122 and/or to the auxiliary I/O device 128. A user of the wireless device 210 may also compose data items, such as email messages, for example, using the keyboard 132 in conjunction with the display 122, the clickable thumbwheel 230, and possibly the auxiliary I/O device 128. The keyboard 132 is preferably a complete alphanumeric keyboard and/or a telephone-type keypad. These composed items may be transmitted over a communication network 220 through the communication subsystem 111 or the short range communication subsystem 141.

For voice communications, the overall operation of the wireless device 210 is substantially similar, except that the received signals would be output to the speaker 134 and signals for transmission would be generated by the microphone 136. Alternative voice or audio I/O subsystems, such as a voice message recording subsystem, may also be implemented on the device 210. Although voice or audio signal output is preferably accomplished primarily through the speaker 134, the display 122 may also be used to provide, for example, an indication of the identity of a calling party, duration of a voice call, or other voice call related information.

The serial port 131 shown in FIG. 2 is normally implemented in a personal digital assistant (“PDA”)-type communication device for which synchronization with a user's desktop computer is a desirable, albeit optional, component. The serial port 131 enables a user to set preferences through an external device or software application and extends the capabilities of the device 210 by providing for information or software downloads to the device 210 other than through a wireless communication network 220. The alternate download path may, for example, be used to load an encryption key onto the device 210 through a direct and thus reliable and trusted connection to thereby provide secure device communication.

The short-range communications subsystem 141 shown in FIG. 2 is an additional optional component which provides for communication between the device 210 and different systems or devices, which need not necessarily be similar devices. For example, the subsystem 141 may include an infrared device and associated circuits and components, or a Bluetooth™ communication module to provide for communication with similarly-enabled systems and devices. (Bluetooth™ is a registered trademark of Bluetooth SIG, Inc.)

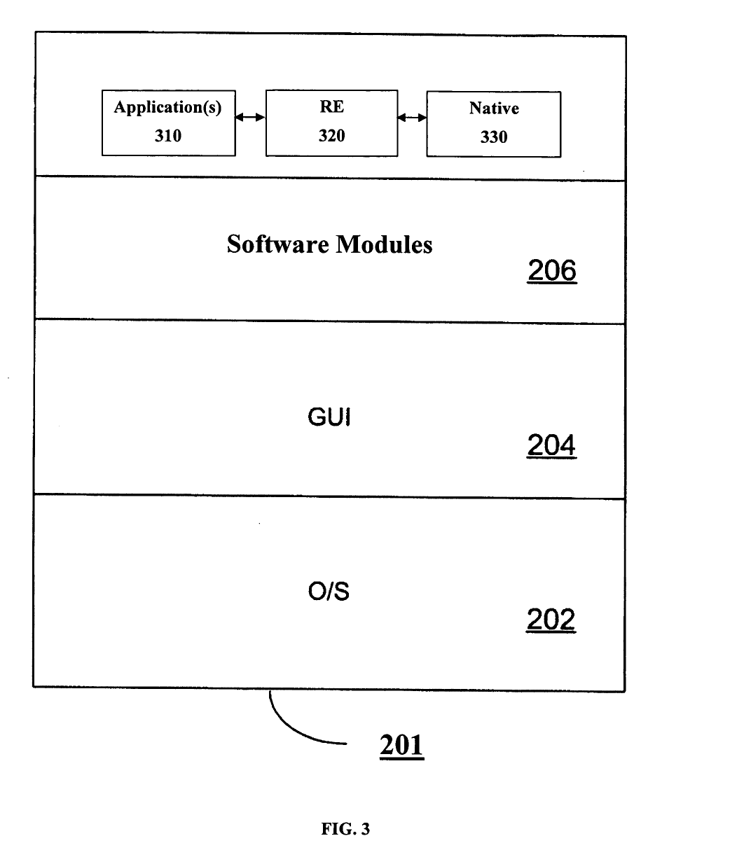

FIG. 3 is a block diagram illustrating a memory 201 of the wireless device 210 of FIG. 2. The memory 201 has various software components for controlling the device 210 and may include flash memory 124, RAM 126, or ROM (not shown), for example. In accordance with an embodiment of the invention, the wireless device 210 is intended to be a multi-tasking wireless communications device configured for sending and receiving data items and for making and receiving voice calls. To provide a user-friendly environment to control the operation of the device 210, an operating system (“O/S”) 202 resident on the device 210 provides a basic set of operations for supporting various applications typically operable through a graphical user interface (“GUI”) 204. For example, the O/S 202 provides basic input/output system features to obtain input from the auxiliary I/O 128, the keyboard 132, the clickable thumbwheel 230, and the like, and for facilitating output to the user. Though not shown, one or more applications for managing communications or for providing personal digital assistant like functions may also be included. In accordance with an embodiment of the invention, there are provided software modules 206 for organizing, introducing, and configuring applications and services in the runtime environment of wireless and other devices as will be described below.

Thus, the wireless device 210 includes computer executable programmed instructions for directing the device 210 to implement the embodiments of the present invention. The programmed instructions may be embodied in one or more software modules 206 resident in the memory 201 of the wireless device 210. Alternatively, the programmed instructions may be embodied on a computer readable medium (such as a CD disk or floppy disk) which may be used for transporting the programmed instructions to the memory of the wireless device 210. Alternatively, the programmed instructions may be embedded in a computer-readable, signal-bearing medium that is uploaded to a network by a vendor or supplier of the programmed instructions, and this signal-bearing medium may be downloaded through an interface 111, 131, 141 to the wireless device 210 from the network by end users or potential buyers.

According to one embodiment of the invention, as shown in FIG. 3, the software modules 206 are designed on a layered model, in which one or more wireless applications 310 control the user's experience of the wireless device 210, and a runtime environment (“RE”) 320 translates between the application software 310 and a native machine-language 330 of the wireless device 210 to control the hardware of the wireless device, to communicate with data services, etc. The applications 310 may be transmitted or downloaded to the wireless device 210 by the data processing system 100 over the wireless network 220. Typically, the applications 310 contain application logic in the form of XML or Java™ script (i.e., ECMA script) and application data, and the RE 320 includes a script interpreter (not shown).

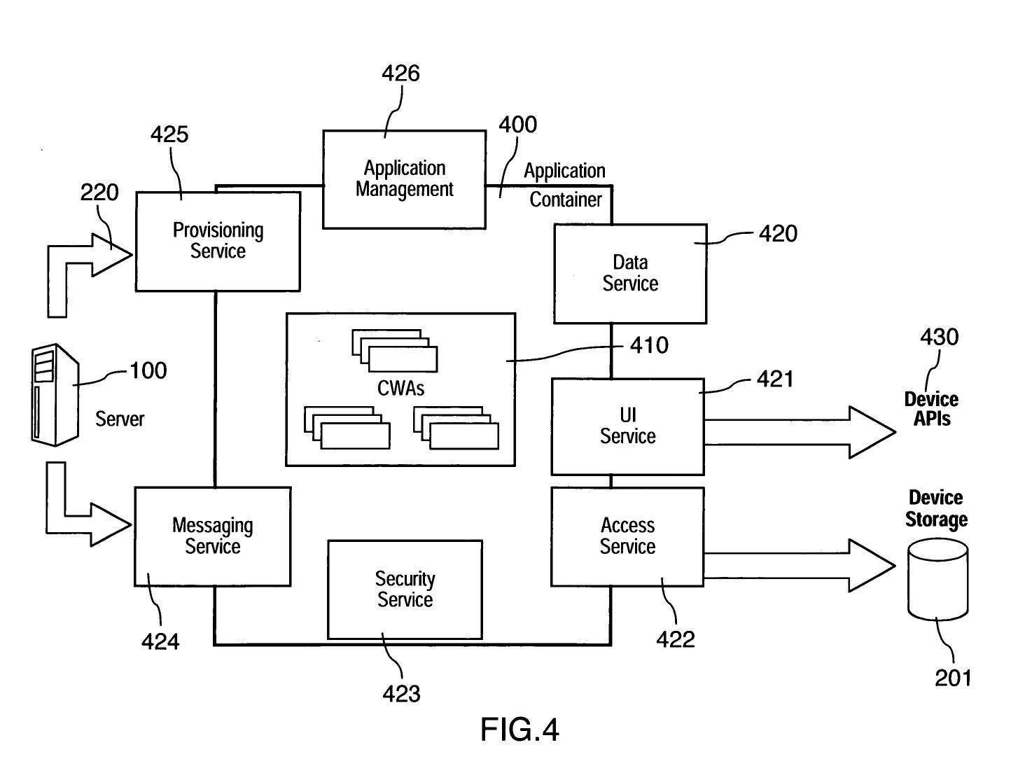

Now, the present invention provides a system and method for implementing selected applications 310 and services in a runtime environment 320 as component wireless applications (“CWAs”) in the runtime environment 320. In this context, the runtime environment 320 is a runtime platform designed for lightweight applications 310 running on a wireless device 210. The CWAs 410 (see FIG. 4) are packaged in an application container 400 along with their dependencies or services.

For reference, in computer programming, an “application container” includes applications and their dependencies or services. As compared to applications that are “welded” to external services, application containers can be more easily managed, isolated from other applications, moved from platform to platform, and treated as unique entities while residing with other applications. An application container is thus a packaging of an application and its dependencies or services which decouples the application from its external infrastructure, creating a unique, stand-alone environment for the application. Dependencies or services may include shared libraries, executables, configuration and environmental settings, scripts, user configurations, application-specific data, etc.

According to the present invention, applications 310 that run in the application container 400 are component-based (hence the word “component” in the term “component wireless application” or CWA 410). A number of fundamental services are provided to CWAs 410, such as messaging, data and application persisting, screen service, executing service, etc. In addition, other customizable services are provided in the form of a CWA with system level privileges, referred to as system component wireless applications (“SCWAs”) in the following, and which use the fundamental services to conduct certain system and management functions for the application container 400.

Thus, according to the present invention, services can be implemented as SCWAs so that replacements, changes, and even the insertion of new services to the runtime environment 320 can be performed by provisioning the replacement, changed, or new SCWAs over-the-air (“OTA”), without restarting the application runtime environment 320, or the application container 400. In OTA provisioning, simple instructions are provided to guide the buyer through the process of activating a wireless device 210 and signing up for wireless services.

FIG. 4 is a block diagram illustrating an application container 400 in accordance with an embodiment of the invention. As shown in FIG. 4, the application container 400 includes a number of services including a data service 420, a user interface (“UI”) service 421, an access service 422, a security service 423, a messaging service 424, a provisioning service 425, and an application management service 426. These services provide functionality for the installation and application management of CWAs 410. In addition, they provide functionality for messaging to and from a data processing system or server 100 over a wireless network 220. For example, CWAs 410 are provisioned for the wireless device 210 from the server 100 by the provisioning service 425. The CWAs 410 in the wireless device 210 can later be removed by the application management service 426. When a CWA 410 runs, it may communicate with the server 100 using the messaging service 424. In FIG. 4, the UI service 421 is linked to one or more application program interfaces (“APIs”) 430 and the access service 422 is linked to a storage device 124, 126 having memory 201.

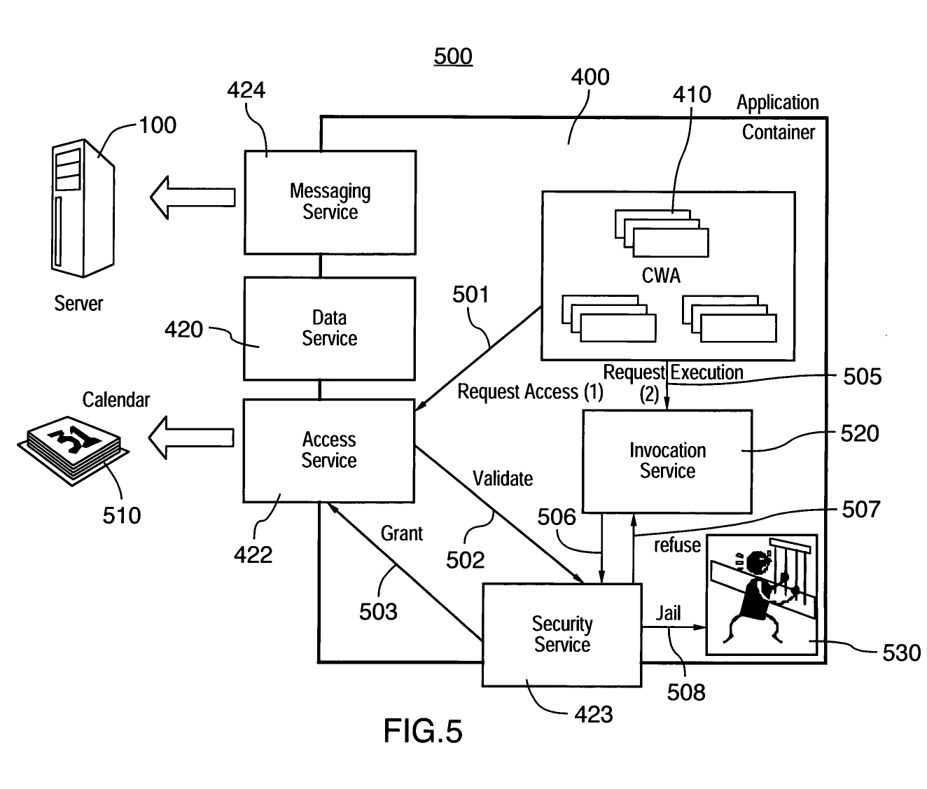

FIG. 5 is a block diagram flow chart illustrating operations 500 of modules 170, 206 for application container access control in accordance with an embodiment of the invention. With respect to access control, in FIG. 4, all access made by a CWA 410 is monitored by the container 400 and controlled by the security service 423 based on a security policy associated with the CWA 410. For example, the CWA 410 may or may not be granted the privilege to do something. As shown in FIG. 5, upon an access request 501 to the access service 422, a CWA 410 is granted access 503 to calendar data 510 by the security service 423 after validation 502. However, upon an execution request 505 to an invocation service 520, the CWA 410 is refused permission 507 to execute another CWA after validation 506. In this case, misbehaviour of the CWA 410 causes the CWA 410 to be “jailed” or quarantined 508, 530. That is, the CWA 410 cannot run until it is activated by an administrator.

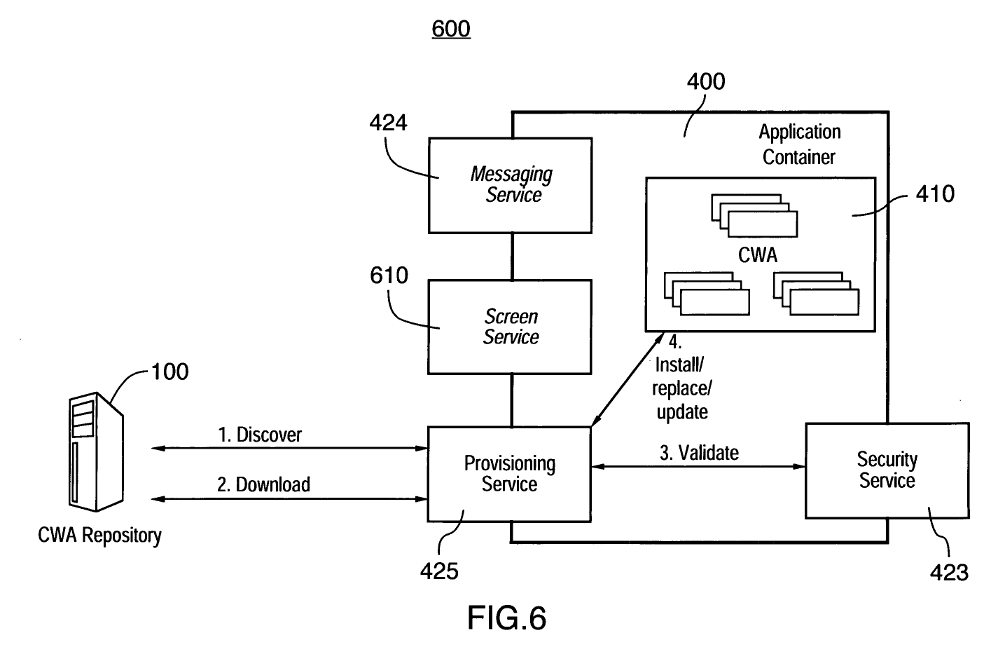

FIG. 6 is a block diagram flow chart illustrating operations 600 of modules 170, 206 for installing, replacing, and updating component wireless applications (“CWAs”) in accordance with an embodiment of the invention. At step 1, a search for a CWA 410 that meets predetermined criteria is performed in a CWA repository in the data processing system or server 100. At step 2, the CWA 410 is downloaded to the wireless device 210 through the provisioning service 425. At step 3, the CWA 410 is validated by the security service 423 based on predetermined security policies. At step 4, the CWA 410 is installed, replaced, or updated in the wireless device 210. The CWA 410 is replaced or updated if an old version is found on the wireless device 210, and if permitted by the user. The CWA 410 is installed if no old version was previously installed.

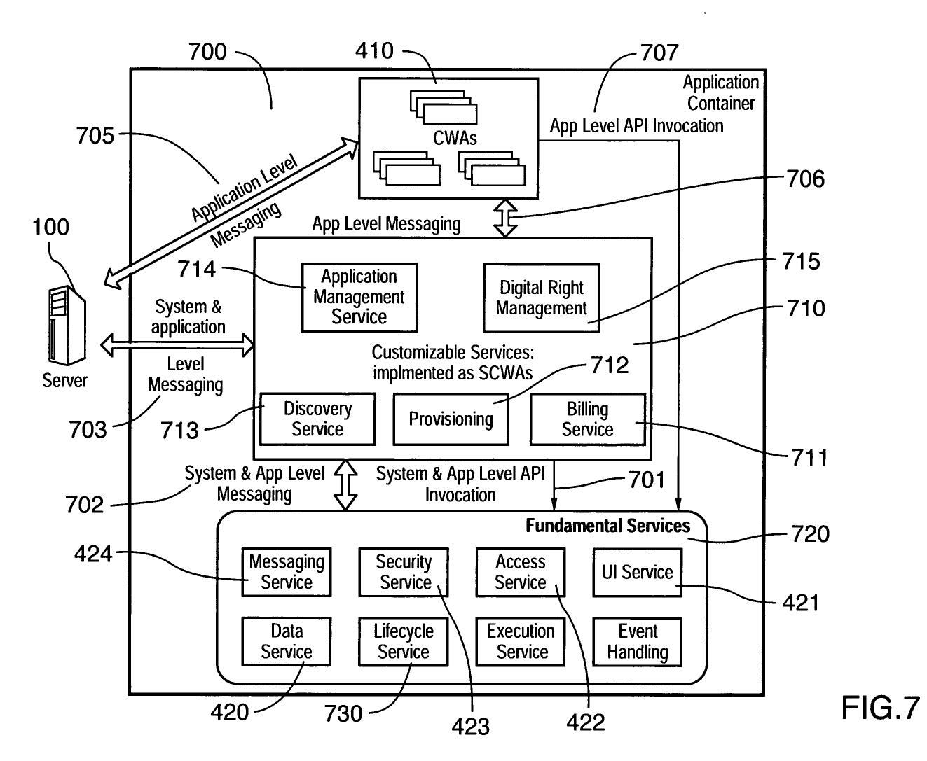

FIG. 7 is a block diagram illustrating an application container 700 having customizable services 710 in accordance with an embodiment of the invention. According to one embodiment, customizable container services can be implemented as system component wireless applications (“SCWAs”) 710, which are CWAs 410 having privileges to access system level APIs 701, to send system messages 702 to local fundamental services 720 (e.g., messaging service 424, UI service 421, access service 422, data service 420, etc.), and to send system messages 703 to remote system services (e.g., billing service 711, provisioning 712, discovery service 713, application management service 714, digital rights management 715, etc.) on the server side.

The application container 700 of FIG. 7 is modified over the application container 400 or FIG. 4 to support SCWAs 710. First, a specific range of CWA application IDs is reserved for SCWAs 710. Particularly, a specific system application ID, or SCWA ID, is associated with each system service. For example, SCWA ID=1 is reserved for the billing service 711.

Second, the security service 423 is modified so as to be aware of the existence of SCWAs 710. The security service 423 may employ application IDs in its authorization decision rendering procedure.

Third, messaging is divided into two portions: system level messaging and application level messaging. Messaging is allowed between CWAS 410 (including SCWAs 710) and the fundamental services 720 and between the server 100 and CWAs 410 (including SCWAs 710). However, only SCWAs 710 are permitted to send and receive system level messages 703. CWAs are only exposed to application level messaging 705, 706.

Fourth, similarly, API invocation is composed of two portions: system API invocation and application level API invocation. System APIs 701, which expose system service functionality, are exclusively used by SCWAs 710. CWAs 410 may only use application level APIs 706.

Since customizable services are implemented as SCWAs 710, they can be installed, updated, and replaced OTA in the same manner as normal CWAs 410, as described above.

Two examples of customizable services 710 will be described in the following: the application management service 714 and the billing service (or billing management system) 711.

The application management service 714 interacts with the local fundamental service 720 and APIS. The main functions of the application management service 714 include the following: displaying the icons of installed applications 310; removing icons if the application 310 is uninstalled; allowing users to choose and view the properties of an application 310; and, allowing users to choose and start an application 310.

A CWA with system privileges, or SCWA 710, is used to implement the application management service 714. In order to perform the above functions, the SCWA 714 works with the local fundamental services 720. For example, the SCWA 714 may send a system notification message 702 to the lifecycle service 730 when an application 310 is installed. In addition, the SCWA 714 may send a system request message 702 to the lifecycle service 730 to remove an application 310 and/or to request application information. The lifecycle service 730 will then respond 702 with the requested application information.

The billing management system (or billing service) 711 interacts with a remote billing service in the data processing system or server 100. The billing management system 711 is useful when a wireless application 310 is designed for pay-per-usage functionality. The main functions of the billing management system 711 include the following: querying current account balance for the user; notifying the user of the new rate for an application and/or of new promotions; recording how many times a specific application is used; etc.

In the case of the billing management system 711, the server side of the billing management system, which may be connected directly to a backend billing information database system 160 in the server 100, would maintain account information for the user, notify the user of new rates or promotions, etc. On the other hand, the wireless device or client side of the billing management system, which is implemented as a SCWA 711, would report to the server each time the application starts or makes a service request successfully.

In this case, system level message exchange 703 between the server 100 and the SCWA 711 on the wireless device 210 plays an important role. For example, first, the server side may send a system notification to the SCWA 711 on the wireless device 210 whenever there is a promotion or rate change. Second, the SCWA 711 may send a system request to the server side asking for account balance information whenever the user inquires about such information. Third, the SCWA 711 may send a system notification to the server side whenever the application is started or a successful service request has been made.

A number of additional customizable services can be implemented as SCWAs 710 including the following: a provisioning service 712 for validating, configuring, and installing CWAs 410 on the wireless device 210; a discovery service 713 for searching for CWAs 410 based on given criteria; and, a digital rights management (“DRM”) service 715 for conducting DRM functions (e.g., protecting content in digital form, restricting access to such content, etc.).

Thus, according to embodiments of the present invention, container services that use fundamental services 720 are implemented as SCWAs 710, which may or may not have access to the UI service 421. Typically, all container services requiring the UI service 421 are implemented as SCWAs 710. In addition, container services implemented as SCWAs 710 can be replaced OTA, in the same way that CWAs can be replaced and updated, without restarting the application container. The addition of new services can be performed in the same way. Furthermore, container services implemented as CWAs 410 have privileges to send system messages and to access system APIs in order to provide services to CWAs 410. Moreover, each CWA 410 is identified in the structure by an unique ID. In order to distinguish a SCWA 710 from a CWA 410, a range of IDs is reserved for SCWAs 710. Finally, because customizable container services are implemented as CWAs, they can provide services not only by interacting with local fundamental services 720 and invoking APIs on the wireless device 210, but also by interacting with remote backend services (e.g., web services, web server, etc.) on the server 100.

The above described method is generally performed by the wireless device 210. However, according to an alternate embodiment of the invention, the method can be performed by the data processing system 100.

While this invention is primarily discussed as a method, a person of ordinary skill in the art will understand that the apparatus discussed above with reference to a wireless device 210 and a data processing system 100, may be programmed to enable the practice of the method of the invention. Moreover, an article of manufacture for use with a wireless device 210 or data processing system 100, such as a pre-recorded storage device or other similar computer readable medium including program instructions recorded thereon, may direct the wireless device 210 or data processing system 100 to facilitate the practice of the method of the invention. It is understood that such apparatus and articles of manufacture also come within the scope of the invention.

The embodiments of the invention described above are intended to be exemplary only. The scope of the invention is therefore intended to be limited solely by the scope of the appended claims.

What is claimed is:

1. A method for introducing a service to a runtime environment of a wireless device, the service for supporting at least one application in the runtime environment, the wireless device communicating over a wireless network with a data processing system, the method comprising:
configuring the service as a system application, wherein the system application is adapted to: communicate system and application level messaging with the data processing system and at least one other service in the runtime environment; and, communicate application level messaging with the at least one application in the runtime environment; and,
installing the system application in the runtime environment as an application.

2. The method of claim 1 wherein the system application is adapted to communicate system and application level application program interface (“API”) invocations to the at least one other service.

3. The method of claim 2 and further comprising assigning an identification number to the system application to distinguish it from other applications in the runtime environment.

4. The method of claim 1 wherein the service includes at least one of an application management service, a digital rights management service, a discovery service, a provisioning service, and a billing service.

5. The method of claim 1 wherein the service is one of a new service and an upgraded service.

6. A system for introducing a service to a runtime environment of the system, the service for supporting at least one application in the runtime environment, the system communicating over a network with a remote system, the system comprising:
a processor coupled to memory and an interface to the network, and adapted to:
configure the service as a system application, wherein the system application is adapted to: communicate system and application level messaging with the remote system and at least one other service in the runtime environment; and, communicate application level messaging with the at least one application in the runtime environment; and,
install the system application in the runtime environment as an application.

7. The system of claim 6 wherein the system application is adapted to communicate system and application level application program interface (“API”) invocations to the at least one other service.

8. The system of claim 7 wherein the processor is further adapted to assign an identification number to the system application to distinguish it from other applications in the runtime environment.

9. The system of claim 6 wherein the service includes at least one of an application management service, a digital rights management service, a discovery service, a provisioning service, and a billing service.

10. The system of claim 6 wherein the service is one of a new service and an upgraded service.

11. The system of claim 6 wherein the system and the remote system include at least one of a wireless device and a data processing system.

12. A computer program product having a computer readable medium tangibly embodying computer executable code for directing a system to introduce a service to a runtime environment of the system, the service for supporting at least one application in the runtime environment, the system communicating over a network with a remote system, the computer program product comprising:
code for configuring the service as a system application, wherein the system application is adapted to: communicate system and application level messaging with the remote system and at least one other service in the runtime environment; and, communicate application level messaging with the at least one application in the runtime environment; and,
code for installing the system application in the runtime environment as an application.

13. The computer program product of claim 12 wherein the system application is adapted to communicate system and application level application program interface (“API”) invocations to the at least one other service.

14. The computer program product of claim 13 and further comprising code for assigning an identification number to the system application to distinguish it from other applications in the runtime environment.

15. The computer program product of claim 12 wherein the service includes at least one of an application management service, a digital rights management service, a discovery service, a provisioning service, and a billing service.

16. The computer program product of claim 12 wherein the service is one of a new service and an upgraded service.

17. The computer program product of claim 12 wherein the system and the remote system include at least one of a wireless device and a data processing system.
